(19) United States
(12) Patent Application Publication
(10) Pub. No.: US 2015/0138692 A1
(43) Pub. Date: May 21, 2015

(54) COATED STRUCTURED SURFACES

(71) Applicant: Dyson Technology Limited, Wiltshire (GB)

(72) Inventors: Gehan Anjil Joseph Amaratunga, Cambridge (GB); Youngjin Choi, Cambridge (GB); Sai Giridhar Shivareddy, Cambridge (GB); Nathan Charles Brown, Swindon (GB); Charles Anthony Neild Collis, Gloucester (GB)

(73) Assignee: Dyson Technology Limited, Wiltshire (GB)

(21) Appl. No.: 14/398,683

(22) PCT Filed: Apr. 25, 2013
(86) PCT No.: PCT/GB2013/051049

§ 371 Date: Nov. 3, 2014

(30) Foreign Application Priority Data
May 3, 2012 (GB) 1207764.0

(51) Int. Cl. H01G 11/04; H01G 11/52; H01G 11/58

(52) U.S. Cl. CPC H01G 11/04; H01G 11/58; H01G 11/52
USPC 361/502; 428/697; 204/471; 204/490

(57) ABSTRACT

Disclosed is a method of coating a structured surface comprising the steps of providing nanoparticles of a first coating material, and depositing the nanoparticles onto a structured surface using electrophoretic deposition. The structured surface may comprise one or more carbon nanotubes which maybe an array. The coating material may be a dielectric material such as barium titanate which may have a particle size of approximately 20 nm diameter. Following the deposition step a second coating may be provided. The second coating may be hafnium oxide. Also disclosed is a capacitor comprising a first electrode of a structured material, a second electrode of conducting material, and a dielectric layer formed between the first and second electrode.

### REFERENCE TO RELATED APPLICATIONS

This application is a national stage application under 35 USC 371 of International Application No. PCT/GB2013/051049, filed Apr. 25, 2013, which claims the priority of United Kingdom Application No. 1207764.0, filed May 3, 2012, the entire contents of which are incorporated herein by reference.

### FIELD OF THE INVENTION

This invention relates to coated structured surfaces, such as coated carbon nanotubes (CNTs) and an array of coated carbon nanotubes.

### BACKGROUND OF THE INVENTION

Many different electrically powered objects such as cars, computers, mobile phones, drills and hand held vacuum cleaners require a portable power source, and there is a drive to provide smaller, lighter and longer lasting portable power sources. Traditionally, portable power sources have tended to be provided by batteries. However, more recently other types of power source have been investigated. One such alternative is capacitors and more specifically supercapacitors.

Capacitors comprise two electric conductors separated by an insulator or dielectric. When a voltage is applied across the conductors, an electric field is generated across the dielectric and energy is stored in this electrical field. The stored energy can potentially be used as a power source. A capacitor can be recharged in a similar manner to rechargeable batteries. Conventional batteries have electric energy stored in a chemical form and the rate at which the battery can be charged or discharged depends on the rate at which the chemical reaction can occur. Dielectric capacitors do not depend on chemical reaction kinetics, and are orders of magnitude faster in terms of charging or discharging the stored electric charge as reflected in the high power densities. In addition, dielectric capacitors have life cycles which are much longer than those of batteries. However, conventional dielectric capacitors do not store enough charge compared to batteries, and therefore have a much lower energy density. A supercapacitor has a higher energy density than a capacitor and thus can store more energy per unit volume. To be a viable alternative to conventional rechargeable batteries, capacitors must have a similar or greater energy density than rechargeable batteries, have a similar cost to the consumer, and be similar in terms of weight and size. These are the technical problems that need to be overcome.

Electrophoresis is the motion of dispersed particles in a solvent under the influence of an electric field. This phenomenon is utilised in electrophoretic deposition (EPD) to coat a substrate with charged particles. EPD has been used to deposit coatings onto planer substrates, as described, for example, in the following publications: Fabrication of Ferroelectric BaTiO3 Films by Electrophoretic Deposition Jpn. J. Appl. Phys. 32 (1993) pp. 4182-4185 by Soichiro Okamura, Takeyo Tsukamoto and Nobuyuki Koura; and Preparation of a Monodispersed Suspension of Barium Titanate Nanoparticles and Electrophoretic Deposition of Thin Films. Journal of the American Ceramic Society, 87: 1578-1581(2004), doi: 10.1111/j.1551-2916.2004.01578.x by 2. Li, J., Wu, Y. J., Tanaka, H., Yamamoto, T. and Kuwabara, M; and Low-temperature synthesis of barium titanate thin films by nanoparticles electrophoretic deposition, JOURNAL OF ELECTROCERAMICS Volume 21, Numbers 1-4, 189-192, DOI: 10.1007/s10832-007-9106-6 by Yong Jun Wu, Juan Li, Tomomi Koga and Makoto Kuwabara,

### SUMMARY OF THE INVENTION

According to a first aspect, the invention provides a method of coating a structured surface comprising the steps of:
(a) providing nanoparticles of a first coating material; and
(b) depositing the nanoparticles onto a structured surface using electrophoretic deposition, and
(c) depositing a second coating over the first coating material.

The inventors have established that the EPD process is advantageous for use with structured surfaces that exhibit metallic behaviours as unlike other techniques such as spin coating and dip coating, EPD has been found to produce a conformal coating on micro and nano structured substrates.

Preferably, the structured surface comprises one or more carbon nanotubes. As carbon exhibits metallic behaviours, it can be used as a substrate for EPD.

Preferably, the carbon nanotubes are formed as an array of carbon nanotubes. This array may be a regular or a random array. It is preferred that chemical vapour deposition (CVD) is used to produce the CNTs; a D.C. plasma enhanced CVD growth chamber may be used to produce oriented nanotubes.

For the production of a regular array of CNTs, a substrate may be lithographically prepared to promote the growth of the CNTs only in specified positions. One preferred growth process consists of four stages:
(a) a substrate pre-treatment (forming a diffusion barrier), where silicon is sputtered with a 30 nm thick layer of niobium;
(b) a catalyst deposition, where a 10 nm thick film of nickel catalyst is deposited onto the substrate;
(c) a catalyst annealing (sintering) stage, where the substrate is heated to 700° C. and held for 10 min to sinter the catalyst layer and to form islands or nano-spheres of the catalyst; and
(d) a nanotube growth, where 200 sccm flow of NH₃ is introduced, a dc discharge between a cathode (the substrate) and an anode is initiated, the bias voltage is increased to −600 V, and a 60 sccm flow of acetylene (C₂H₂) feed gas is introduced.

In one example, the total pressure was maintained at 3.8 mbar and the depositions were carried out for 10 min in a stable discharge.

In a preferred embodiment, the structured surface comprises a random array of structures, preferably CNTs. Such a random array is also known as supergrowth and has significantly higher growth rate than a regular array. Preferably, the spacing to length ratio of the structures is a maximum of 1:30.

For supergrowth or random CNTs, a preferred growth process is as follows:
(a) a substrate is coated with a 2-4 nm thick layer of aluminium;
(b) a 2-4 nm thick film of iron (Fe) catalyst is sputtered on the aluminium layer, using a metal sputter coating equipment with a base pressure of 10⁻⁵ mbar; and
(c) the coated substrate is annealed at 600° C. within an NH₃ environment for 10 minutes, and then 2 sccm C₂H₂ is introduced into the chamber to grow CNTs.

The CNT growth stage preferably has a duration which is no greater than 10 minutes, preferably between 1 and 10 minutes, even more preferably between 1 and 3 minutes. The aluminium layer is a barrier layer, and is used to form a thin alumina layer during the annealing process step. This thin oxide layer assists in forming iron nano-islands to grow CNTs in a high density. The substrate may be any conductive substrate. Preferably, the substrate is a copper or a silicon substrate. Alternatively, the substrate may be a graphite substrate.

In a preferred embodiment, the coating material is a dielectric material. Preferably the coating material is barium titanate (BaTiO₃). Preferably, the particle size of the barium titanate is in the range of 70-150 nm More preferably, the barium titanate nanoparticles are 5-20 nm in diameter.

In one embodiment, the nanoparticles are agitated ultrasonically prior to being deposited onto the structured surface. This ultrasonic agitation shatters the nanoparticles into smaller particles, providing better coverage or a more conformal coating of the structured surface.

Advantageously, the material used in the second coating has properties which are complimentary to the first coating material. The second material provides a composite coating ensuring that the structured surface is completely coated. It is advantageous to have a complete coating as this stops any direct interaction between the structured surface and an external environment, for example in the case where the structured surface is an electrode of a capacitor, and so where direct interaction of the two electrodes would cause leakage of charge.

Preferably, the second coating material is a dielectric or high k metal oxide coating such as hafnium oxide, titanium dioxide, barium titanate and barium strontium titanate. Such coatings can be produced by various methods including but not limited to conformal atomic layer deposition (ALD), plasma enhanced ALD (PEALD), physical vapour deposition (PVD), pulsed laser deposition (PLD), metal organic chemical vapour deposition (MOCVD), plasma enhanced chemical vapour deposition (PECVD) and sputter coating.

In addition various polymer materials having relatively high K values can be used to form the dielectric, such as cyanoresins (CR-S), polyvinylidene fluoride-based polymers such as Pvdf:Trfe, or PVDF:TrFE:CFE, which can be spin coated onto the BTO coated CNTs. Self assembled monolayer coatings of phosphonic acids can also function as an additional coating to further reduce the leakage current.

The ALD process may comprise a plurality of deposition cycles, with each deposition cycle comprising the steps of (i) introducing a precursor to a process chamber, (ii) purging the process chamber using a purge gas, (iii) introducing an oxygen source as a second precursor to the process chamber, and (iv) purging the process chamber using the purge gas. The oxygen source may be one of oxygen and ozone. The purge gas may be argon, nitrogen or helium. To deposit hafnium oxide, an alkylamino hafnium compound precursor may be used. To deposit titanium dioxide, a titanium isopropoxide precursor may be used. Each deposition cycle is preferably performed with the substrate at the same temperature, which is preferably in the range from 200 to 300° C., for example 250° C. Each deposition step preferably comprises at least 100 deposition cycles. For example, an ALD deposition may comprise 200 to 400 deposition cycles to produce a hafnium oxide coating having a thickness in the range from 25 to 50 nm Where the deposition cycle is a plasma enhanced deposition cycle, step (iii) above preferably also includes striking a plasma, for example from argon or from a mixture of argon and one or more other gases, such as nitrogen, oxygen and hydrogen, before the oxidizing precursor is supplied to the chamber.

It is preferred that the dielectric coating is produced in a two step ALD process, whereby a first layer of the coating is deposited, followed by a pause in the deposition process and then a second layer of the second coating is deposited. This two step coating is applicable to both plasma only and combined plasma and thermal ALD coating methods. The pause is a break or delay in the deposition process which has been found advantageous to certain properties of the material deposited on the substrate. The delay preferably has a duration of at least one minute. The delay is preferably introduced to the deposition by supplying a purge gas to a process chamber in which the substrate is located for a period of time of at least one minute between the first deposition step and the second deposition step. Each deposition step preferably comprises a plurality of consecutive deposition cycles. Each of the deposition steps preferably comprise at least fifty deposition cycles, and at least one of the deposition steps may comprise at least one hundred deposition cycles. In one example, each of the deposition steps comprises two hundred consecutive deposition cycles. The duration of the delay between the deposition steps is preferably longer than the duration of each deposition cycle. The duration of each deposition cycle is preferably in the range from 40 to 50 seconds.

The delay between deposition steps may be provided by a prolonged duration of a period of time for which purge gas is supplied to the process chamber at the end of a selected one of the deposition cycles. This selected deposition cycle may occur towards the start of the deposition process, towards the end of the deposition cycle, or substantially midway through the deposition process.

According to a second aspect, the invention provides a method of manufacturing a capacitor having an electrode with a structured surface, comprising the steps of:
(a) providing a first electrode comprising a structured surface;
(b) depositing nanoparticles of a first dielectric material onto the structured surface using electrophoretic deposition to produce a coated structured surface;
(c) depositing a second coating over the coated structured surface; and
(d) depositing a second electrode of conducting material over the coated structured surface.

Preferably, the first dielectric material is barium titanate. It is preferred that the barium titanate particles are approximately 20 nm in diameter.

It is preferred that the second coating is formed using atomic layer deposition. Preferably, the second coating is hafnium oxide.

Alternatively, the second coating may be formed using physical layer deposition. IN this case, the second coating may be barium titanate.

Preferably, the second electrode is produced using evaporation of a conducting material for example aluminium or galinstan.

According to a third aspect the invention provides a capacitor comprising:
a first electrode of a structured material;
a second electrode of a conducting material; and
a dielectric layer formed between the first and second electrodes, wherein the dielectric layer comprises a first layer and a second layer.

Preferably, the structured material is an array of CNTs. The array may be regular or random.

Preferably, the dielectric layer is formed using EPD; when the structured surface is coated with a dielectric material using EPD, this results in the production of a conformal coating. This provides a less leaky material, as the two electrodes do not come into direct contact. It is preferred that the dielectric layer is formed from barium titanate.

The dielectric layer comprises a first layer and a second layer. Preferably the first layer is barium titanate. It is preferred that the second layer is hafnium oxide.

To form a capacitor a second electrode is required. It is preferred that the second electrode is formed from a metal or intermetallic material such as, but not limited to aluminium, titanium nitride, ruthenium, and platinum which can be deposited onto the coated CNT using ALD for example. In addition, a liquid metal such as galinstan may be evaporated onto the structure.

### BRIEF DESCRIPTION OF THE DRAWINGS

The invention will now be described by example with reference to the accompanying drawings, of which:

FIG. 1 shows an electrophoretic deposition chamber;

FIGS. 2a and 2b show images of barium titanate deposited by EPD onto CNTs;

FIGS. 3a and 3b show TEM and TEM diffraction images of barium titanate particles;

FIGS. 4a and 4b show synthesised and commercial barium titanate nanoparticle coatings;

FIG. 5 shows a CNT array with a second coating of hafnium oxide produced by ALD;

FIG. 6 is a graph of dielectric constant against voltage to illustrate the effect of different pause lengths on the capacitance of a titanium oxide coating; and

FIG. 7 shows a CNT array with a second coating of barium titanate produced by PLD.

### DETAILED DESCRIPTION OF THE INVENTION

A regular array of CNT's was grown by PECVD (plasma enhanced chemical vapour deposition) on an e-beam lithography patterned high conductivity p-Si substrate with a 25 mm² area.

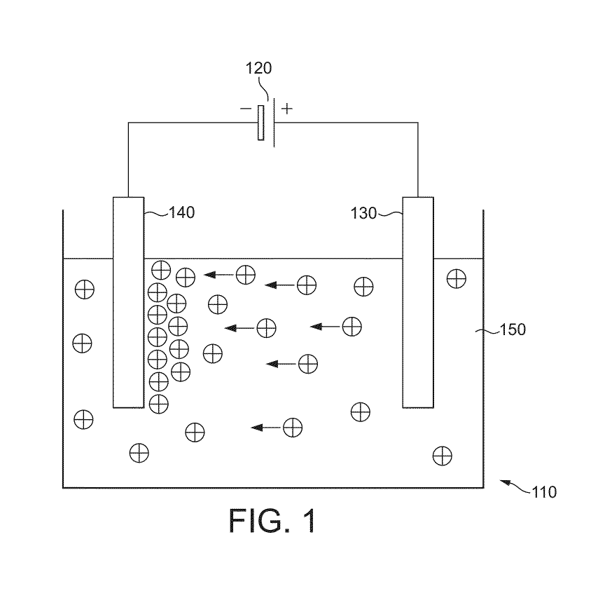

FIG. 1 shows an electrophoretic deposition chamber. The chamber includes a container 110 and a power source 120 connected to a positive electrode or anode 130 and a negative electrode or cathode 140. During the deposition process the two electrodes 130, 140 are at least partially submerged in a solution 150 and the power source 120 is turned on to create an electric field and attract positive ions to the cathode 130.

The solution 150 comprises a 1g/litre concentration of barium titanate, BaTiO₃, (BTO) particles dissolved in water. The negative electrode 140 is a CNT array and when the power source 120 is switched on positively charged BTO particles are attached to the negative electrode and thereby coat the CNT array. The solutions of BTO had nanoparticles of size range 70-150 nm. The nanoparticles were dispersed in the solution for 6 hours by ultrasonication using a tip sonicator at 200 to 250 W to produce a stable suspension which was transferred to an electrophoretic cell with electrodes 2 cm apart.

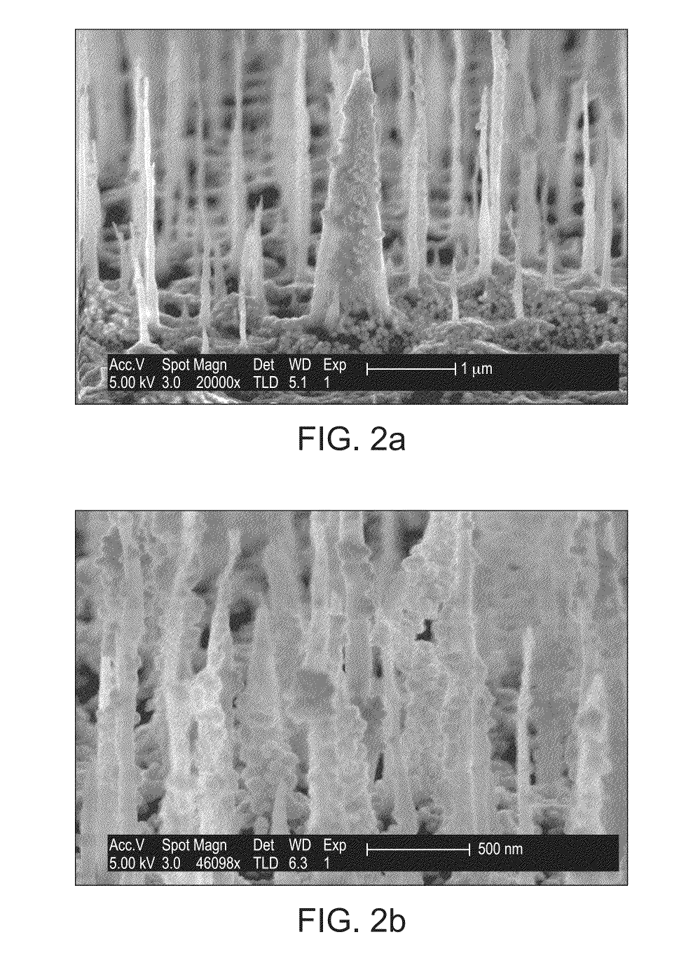

FIG. 2a shows a BTO coating on a regular CNT array formed by carrying out an electrodeposition process at 10V for 5 seconds and FIG. 2b shows a BTO coating on a regular CNT array formed by carrying out an electrodeposition process at 10V for 5 minutes.

Unlike when BTO is deposited using EPD on flat substrates where film thickness scales linearly with concentration and dilution results in denser films, when structured substrates are used the growth rate depends on DC bias and concentration of the suspension.

Although EPD provides a conformal coating, the size of the BTO particles results in a non-continuous coating. One partial solution to this is to use smaller particles. Two different techniques were used to produce smaller particles.

In a first technique BTO nanoparticles were prepared solvothermally or hydrothermally using barium hydroxide octahydrate and titanium (IV) tetraisopropoxide. The resulting nanoparticles were 5-20 nm in diameter with cubic perovskite phase crystallinity. The reactants were as follows:

Ba(OH)₂+8H₂O+Ti{OCH(CH₃)₂}₄(Titanium isopropoxide)+Ethanol (60 ml)

The solution was placed in a water bath at 50° C. for 4 hours under magnetic stirring. Then, the product of the reaction was washed with formic acid, ethanol, and finally de-ionised water and subsequently dried at 50° C. for 6 hours in vacuum.

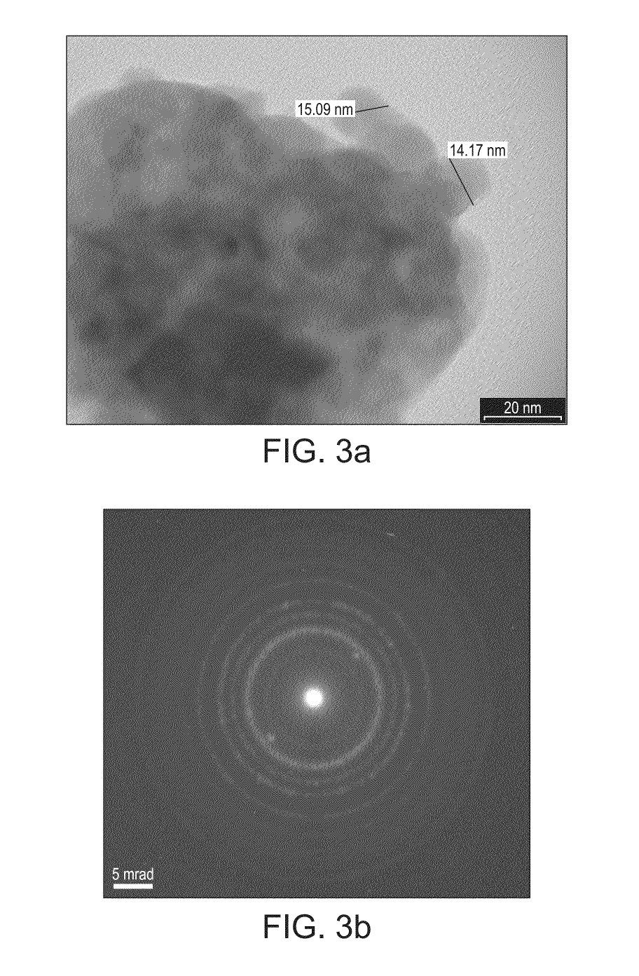

In a second technique, commercially available 70-150 nm BTO nanoparticles (available from Sigma-Aldrich) which are generally spherical in shape were subjected to high power ultrasonication which caused shattering of the particles to approximately 20 nm in size (with a range of 4 nm-25 nm). FIG. 3a shows a TEM image and FIG. 3b shows a TEM diffraction image of the barium titanate particles following ultrasonication.

The larger particles were suspended in water using a tip sonicator at 200 W to 250 W for 6 to 12 hours. A tip sonicator provides more power per unit volume at the tip than an ultrasonic bath. This technique is usually carried out using an organic solvent to disperse the particles rather than water as water dissolves the particles. However, it is thought that particles dissolve in the water and then re-crystallise because of the high energy input at the tip of the tip sonicator to produce sharp fragments of BTO. There is natural circulation of the particles within the suspension due to the tip sonicator so a constant stream of material is provided near the tip. Once the sonication process was complete, the suspension was left for at least one hour to enable settling of the larger particles to the bottom of the suspension.

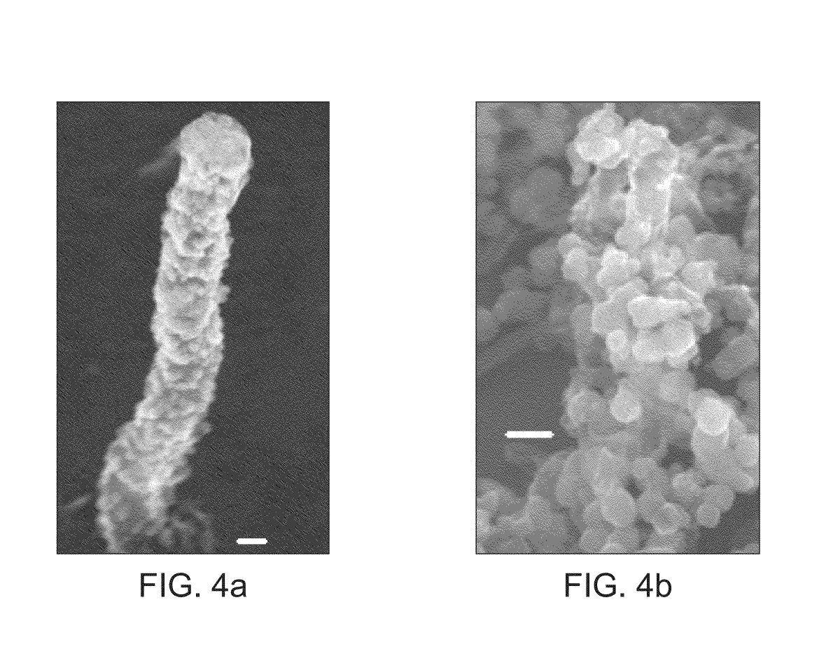

These nanoparticles were then coated onto CNTs using EPD. FIG. 4a shows a CNT coated with the smaller ultrasonicated BTO particles (scale bar 40 nm) and FIG. 4b shows a CNT coated with the commercially available BTO having a particle size in the range 70-150 nm (scale bar 100 nm). The coating made using the smaller particles required more time to grow, that is, around 2 hours. The smaller particles clearly produce a more conformal coating on the CNT as the particle sizes (around 5-20 nm) are smaller than the diameter of a CNT, which is around 50-60 nm.

However, the coated CNTs were still electrically leaky, and this is considered to be due to the coating not being continuous and, as the nanoparticles deposit much better on the nanotubes than on the silicon substrate, which creates a leakage path between the two electrodes. It is important for a capacitor to have a good, complete insulating layer otherwise stored charge will be lost over time. To mitigate this problem, a second coating material was provided. This second coating is preferably a material with a high K value i.e. high permittivity.

Examples of compounds which are suitable for use as the second coating material include, but is not limited to, high k metal oxide coatings such as hafnium oxide, titanium dioxide, barium titanate, and barium strontium titanate, which can be coated by various methods including but not limited to conformal atomic layer deposition (ALD), plasma enhanced ALD (PEALD), physical vapour deposition (PVD), pulsed laser deposition (PLD), metal organic chemical vapour deposition (MOCVD), plasma enhanced chemical vapour deposition (PECVD) and sputter coating. In addition various polymer materials having relatively high K values are available such as cyanoresins (CR-S), polyvinylidene fluoride based polymers like Pvdf:Trfe, PVDF:TrFE:CFE, which can be spin coated onto the BTO coated CNTs. Self assembled monolayer coatings of phosphonic acids can also function as an additional coating to further reduce the leakage current.

A PEALD process was conducted using a Cambridge Nanotech Fiji 200 plasma ALD system. The substrate was located in a process chamber of the ALD system which was evacuated to a pressure in the range from 0.3 to 0.5 mbar during the deposition process, and the substrate was held at a temperature of around 250° C. during the deposition process. Argon was selected as a purge gas, and was supplied to the chamber at a flow rate of 200 sccm for a period of at least 30 seconds prior to commencement of the first deposition cycle.

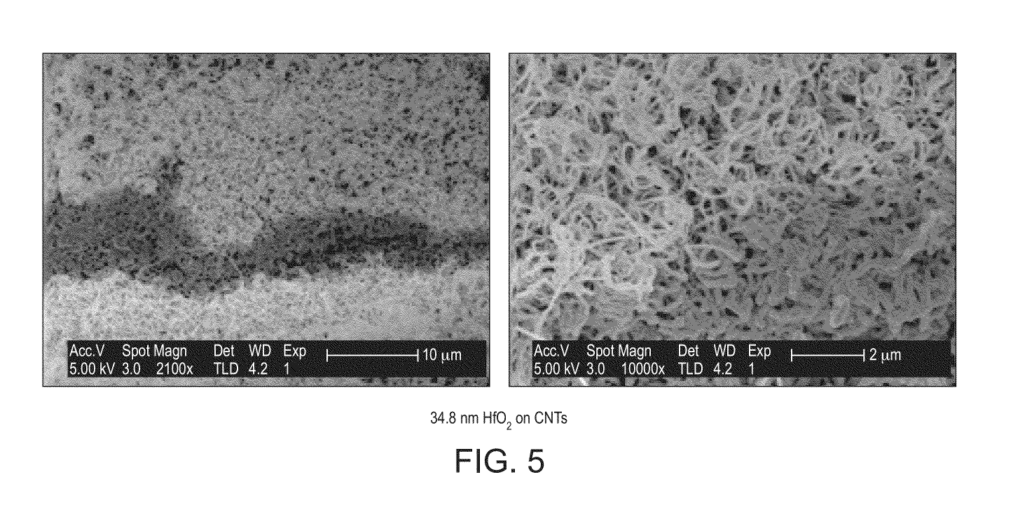

An example of a second coating is shown in FIG. 5, where hafnium oxide (HfO₂) has been deposited by ALD onto a BTO coated CNT.

A preferred PEALD process to form a hafnium oxide coating comprises a series of deposition cycles. Each deposition cycle commences with a supply of a hafnium precursor to the deposition chamber. The hafnium precursor was tetrakis dimethyl amino hafnium (TDMAHf, Hf(N(CH₃)₂)₄). The hafnium precursor was added to the purge gas for a period of 0.25 seconds. Following the introduction of the hafnium precursor to the chamber, the purge gas was supplied for a further 5 seconds to remove any excess hafnium precursor from the chamber. A plasma was then struck using the argon purge gas. The plasma power level was 300 W. The plasma was stabilised for a period of 5 seconds before oxygen was supplied to the plasma at a flow rate of 20 sccm for a duration of 20 seconds. The plasma power was switched off and the flow of oxygen stopped, and the argon purge gas was supplied for a further 5 seconds to remove any excess oxidizing precursor from the chamber, and to terminate the deposition cycle.

The deposition process was a discontinuous PEALD process, comprising a first deposition step, a second deposition step, and a delay between the first deposition step and the second deposition step. The first deposition step comprised 200 consecutive deposition cycles, again with substantially no delay between the end of one deposition cycle and the start of the next deposition cycle. The second deposition step comprised further 200 consecutive deposition cycles, again with substantially no delay between the end of one deposition cycle and the start of the next deposition cycle. The delay between the final deposition cycle of the first deposition step and the first deposition cycle of the second deposition step was in the range from 1 to 60 minutes. During the delay, the pressure in the chamber was maintained in the range from 0.3 to 0.5 mbar, the substrate was held at a temperature of around 250° C., and the argon purge gas was conveyed continuously to the chamber at 20 sccm. This delay between the deposition steps may also be considered to be an increase in the period of time during which purge gas is supplied to the chamber at the end of a selected deposition cycle. The thicknesses of coatings produced by both deposition processes were around 36 nm.

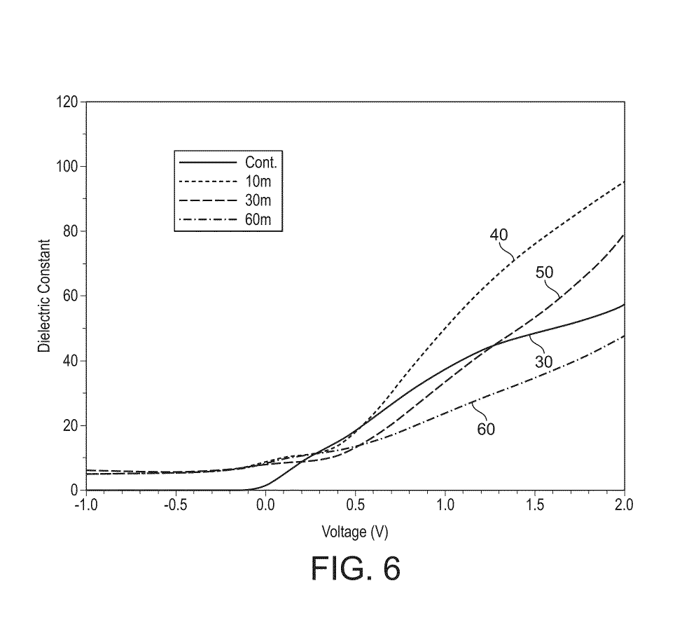

Titanium dioxide coatings where also deposited onto a BTO coated CNT. FIG. 6 is graph of dielectric constant against voltage to illustrate the effect of different pause lengths on the capacitance of a titanium oxide coating.

Four titanium dioxide coatings were formed on respective silicon substrates, each using a different respective deposition process. The first deposition process was a standard PEALD process comprising 400 consecutive deposition cycles, with substantially no delay between the end of one deposition cycle and the start of the next deposition cycle, and the variation in dielectric constant of the resultant coating with voltage is indicated at 30 in FIG. 6.

The second deposition process was a discontinuous PEALD process, comprising a first deposition step, a second deposition step, and a delay between the first deposition step and the second deposition step. The first deposition step comprised 200 consecutive deposition cycles, again with substantially no delay between the end of one deposition cycle and the start of the next deposition cycle. The second deposition step comprised further 200 consecutive deposition cycles, again with substantially no delay between the end of one deposition cycle and the start of the next deposition cycle. The delay between the final deposition cycle of the first deposition step and the first deposition cycle of the second deposition step was 10 minutes. During the delay, the pressure in the chamber was maintained in the range from 0.3 to 0.5 mbar, the substrate was held at a temperature of around 250° C., and the argon purge gas was conveyed to the chamber at 20 sccm. The variation in dielectric constant of the resultant coating with voltage is indicated at 40 in FIG. 6.

The third deposition process was similar to the second deposition process, but with a delay of 30 minutes, and the variation in dielectric constant of the resultant coating with voltage is indicated at 50 in FIG. 6. The fourth deposition process was similar to the second deposition process, but with a delay of 60 minutes, and the variation in dielectric constant of the resultant coating with voltage is indicated at 60 in FIG. 6.

At negative voltages the graphs for the discontinuous processes are very similar, and the dielectric constant is higher than the zero voltage level for the continuous deposition process. At positive voltage, the coating produced using the second deposition process had the highest dielectric constant.

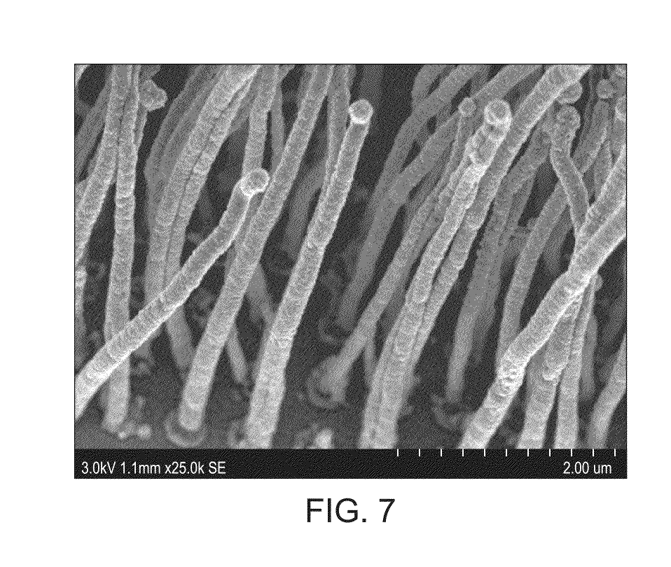

FIG. 7 shows an example of a second coating of barium titanate formed using a PLD process. The barium titanate film was deposited at 700° C. in an oxygen partial pressure of 50 mTorr and 1400 laser pulses at 5 Hz repetition rate. A custom made vacuum deposition chamber with KrF excimer UV laser was used. A laser energy of 1-2 J/cm² and oxygen atmospheres of between 0.06-0.2 mbar (50-150 mTorr) were employed to optimize the perovskite oxide films on multi-walled CNTs utilizing a KrF excimer laser (λ=240 nm) at different repetition rates. After the deposition of the perovskite film, the chamber was cooled at a rate of 10 degree/minute to room temperature in an oxygen atmosphere at 400 mbar (300 Torr). The PLD coating produced was 60 nm thick.

The use of a second coating produces a coated material having a lower leakage current and lower capacitance.

The coated nanotubes can be used in a capacitor or as a three dimensional ferroelectric memory.

To form a capacitor, a second electrode is required. It is preferred that the second electrode is formed from a metal or intermetallic material such as, but not limited to, aluminium, titanium nitride, ruthenium, and platinum which can be deposited onto the coated CNT using ALD for example or evaporated using an Edwards vacuum evaporator. In addition, a liquid metal alloy such as galinstan may be evaporated onto the structure.

For example a metal-insulator-semiconductor (Al/HfO₂/n-Si) capacitor structure was made by applying dots of aluminum on top of the hafnium oxide coated silicon substrate. The dots were 0.5 mm in diameter and were made by evaporation of aluminum. The four hafnium oxide-coated silicon substrates were formed using the four different deposition processes. A first hafnium oxide-coated silicon substrate was formed using a continuous process. A second hafnium oxide-coated silicon substrate was formed with a delay having a duration of 1 minute instead of 10 minutes. A third hafnium oxide-coated silicon substrate was formed with a delay having a duration of 30 minutes instead of 10 minutes. A fourth hafnium oxide-coated silicon substrate was formed with a delay having a duration of 60 minutes instead of 10 minutes. In all cases the delay occurred after 200 deposition cycles. The capacitance-voltage characteristics of the four coatings have very little hysteresis and the presence of the delay between the deposition steps provides an increase in the capacitance of the capacitor.

1-27. (canceled)

28. A method of coating a structured surface, comprising the steps of:
(a) providing nanoparticles of a first coating material;
(b) depositing the nanoparticles onto a structured surface using electrophoretic deposition; and
(c) depositing a second coating over the first coating material.

29. The method of claim 28, wherein the structured surface comprises carbon nanotubes grown as an array on a substrate.

30. The method of claim 28, wherein the coating material is a dielectric material.

31. The method of claim 28, wherein the coating material is barium titanate.

32. The method of claim 31, wherein the barium titanate particles are approximately 20 nm in diameter.

33. The method of claim 28, wherein the second coating is deposited using an atomic layer deposition process.

34. The method of claim 33, wherein the second coating is a hafnium oxide coating.

35. The method of claim 28, wherein the second coating is deposited using a physical layer deposition process.

36. The method of claim 35, wherein the second coating is a barium titanate coating.

37. A capacitor comprising a coated structured surface, the capacitor being manufactured by:
(a) providing nanoparticles of a first coating material on a structured surface of the capacitor;
(b) depositing the nanoparticles onto the structured surface of the capacitor using electrophoretic deposition; and
(c) depositing a second coating over the first coating material onto the structured surface of the capacitor.

38. A method of manufacturing a capacitor having an electrode with a structured surface, comprising the steps of:
(a) providing a first electrode comprising a structured surface;
(b) depositing nanoparticles of a dielectric material onto the structured surface using electrophoretic deposition to produce a coated structured surface;
(c) depositing a second coating over the coated structured surface; and
(d) depositing a second electrode of conducting material over the coated structured surface.

39. The method of claim 38, wherein the structured surface comprises carbon nanotubes grown as an array on a substrate.

40. The method of claim 38, wherein the dielectric material is barium titanate.

41. The method of claim 38, wherein the second coating is deposited using atomic layer deposition.

42. The method of claim 41, wherein the second coating is hafnium oxide.

43. The method of claim 38, wherein the second coating is deposited using physical layer deposition.

44. The method of claim 43, wherein the second coating is barium titanate.

45. The method of claim 38, wherein the second electrode is deposited by the evaporation of a conducting material.

46. A capacitor comprising;
a first electrode of a structured material;
a second electrode of conducting material; and
a dielectric layer formed between the first and second electrode, wherein the dielectric layer comprises a first layer and a second layer.

47. The capacitor of claim 46, wherein the structured surface comprises carbon nanotubes grown as an array on a substrate.

48. The capacitor of claim 46, wherein the dielectric layer is formed using electrophoretic deposition.

49. The capacitor of claim 48, wherein the dielectric layer is barium titanate.

50. The capacitor of claim 46, wherein the first layer is barium titanate.

51. The capacitor of claim 46, wherein the second layer is hafnium oxide.

52. The capacitor of claim 46, wherein the second electrode is formed from aluminium or galinstan.

53. The method of claim 29, wherein the coating material is a dielectric material.

54. The method of claim 39, wherein the dielectric material is barium titanate.

55. The method of claim 39, wherein the second coating is deposited using atomic layer deposition.

56. The method of claim 39, wherein the second coating is deposited using physical layer deposition.

57. The capacitor of claim 47, wherein the dielectric layer is formed using electrophoretic deposition.
